(19) United States
(12) Patent Application Publication
(10) Pub. No.: US 2022/0377220 A1
(43) Pub. Date: Nov. 24, 2022

(54) CAMERA

(71) Applicant: NIDEC COPAL CORPORATION, Tokyo (JP)

(72) Inventor: Yuusuke SUZUKI, Tokyo (JP)

(21) Appl. No.: 17/745,876

(22) Filed: May 17, 2022

(30) Foreign Application Priority Data
May 21, 2021 (JP) 2021-086015

(51) Int. Cl. H04N 5/225

(52) U.S. Cl. CPC H04N 5/22525; H04N 5/2253; H04N 5/2252

(57) ABSTRACT

A camera can be in a non-imaging mode in a manner clearly noticeable to any person being imaged. A camera includes an imaging unit, a display unit that displays an image, a driver that moves the imaging unit and the display unit integrally, and a housing having an opening connecting an inside and an outside of the housing. The housing accommodates the imaging unit, the display unit, and the driver. The driver moves the imaging unit and the display unit to a first position at which the imaging unit is enabled to capture an image through the opening. The driver moves the imaging unit and the display unit to a second position at which an image displayed by the display unit is visible through the opening.

### RELATED APPLICATIONS

The present application claims priority to Japanese Application Number 2021-086015, filed May 21, 2021, the disclosure of which is hereby incorporated by reference herein in its entirety.

### BACKGROUND

### Technical Field

The present invention relates to a camera for capturing moving images and still images.

### Description of the Background

Cameras such as surveillance cameras and monitoring cameras are installed today in various places such as hospitals, nursing care facilities, factories, stores, and homes. Other cameras such as webcams and live cameras connectable to the Internet are also used in various places such as offices and homes. Such cameras are to be used with personal privacy protection. Patent Literatures 1 and 2 describe cameras with personal privacy protection.

### CITATION LIST

### Patent Literature

Patent Literature 1: U.S. Patent Application Publication No. 2020/0249415

Patent Literature 2: U.S. Patent Application Publication No. 2020/0363699

### BRIEF SUMMARY

In use of such cameras, personal privacy is to be protected, and also any person being imaged is to be least stressful. In response to this, such cameras are to be switchable between an imaging mode and a non-imaging mode and are also to be in the non-imaging mode in a manner clearly noticeable to any person being imaged.

A camera according to one embodiment includes an imaging unit, a display unit that displays an image, a driver that moves the imaging unit and the display unit integrally, and a housing having an opening connecting an inside and an outside of the housing. The housing accommodates the imaging unit, the display unit, and the driver. The driver moves the imaging unit and the display unit to a first position at which the imaging unit is enabled to capture an image through the opening. The driver moves the imaging unit and the display unit to a second position at which an image displayed by the display unit is visible through the opening.

The camera according to the above embodiment of the present invention can be in the non-imaging mode in a manner clearly noticeable to any person being imaged.

### BRIEF DESCRIPTION OF DRAWINGS

FIG. 1 is an external perspective view of a camera in an imaging mode.

FIG. 2 is an external perspective view of the camera in a non-imaging mode.

FIG. 3 is an exploded perspective view of the camera.

FIG. 4 is a schematic cross-sectional view of an imaging unit and a display unit.

FIG. 5A is a diagram of the imaging unit and the display unit at a first position.

FIG. 5B is a diagram of the imaging unit and the display unit at a second position.

### DETAILED DESCRIPTION

One or more embodiments of the present invention will now be described in detail with reference to the drawings. In the drawings used to describe the embodiments, the same reference numerals denote the same or substantially the same components or elements. Such components or elements will not basically be described repeatedly.

### Overview of Camera

A camera according to the present embodiment may be used for any purpose, and may be installed in, for example, hospitals, nursing care facilities, factories, stores, and homes as a surveillance camera or a monitoring camera. The camera according to the present embodiment may also be used as a webcam or a live camera connectable to the Internet.

The camera according to the present embodiment is switchable between an imaging mode and a non-imaging mode. More specifically, the camera according to the present embodiment includes an imaging unit for capturing images such as moving images and still images. The imaging unit is switchable between a mode in which imaging is enabled (imaging mode) and a mode in which imaging is disabled (non-imaging mode).

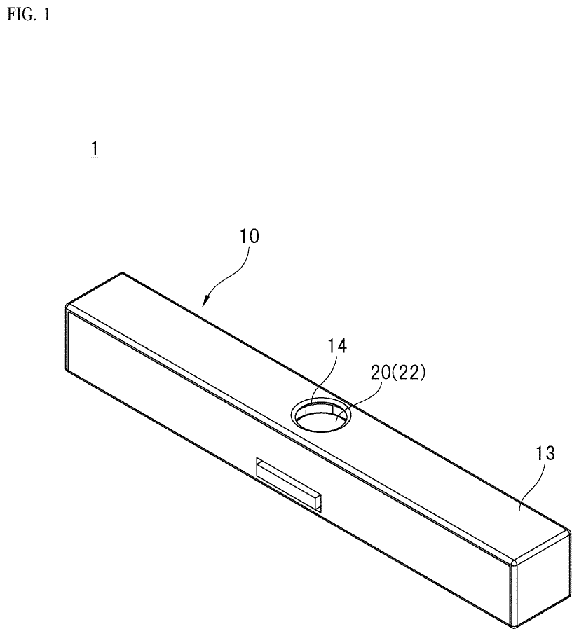

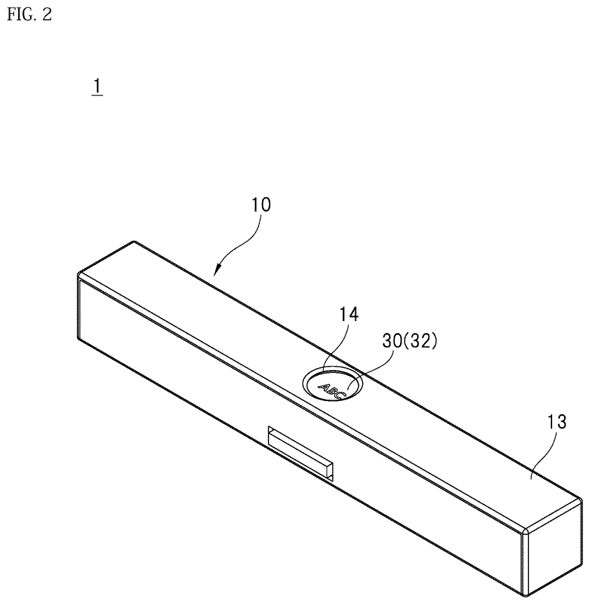

FIGS. 1 and 2 each are an external perspective view of a camera 1 according to the present embodiment. More specifically, FIG. 1 is an external perspective view of the camera 1 in the imaging mode, and FIG. 2 is an external perspective view of the camera 1 in the non-imaging mode.

The camera 1 is switchable between the imaging mode and the non-imaging mode with, for example, a user operation. The camera 1 is also switchable between the imaging mode and the non-imaging mode in response to a remote operation performed with another device or a state change (e.g., power being on or off) of any connected device.

### Housing

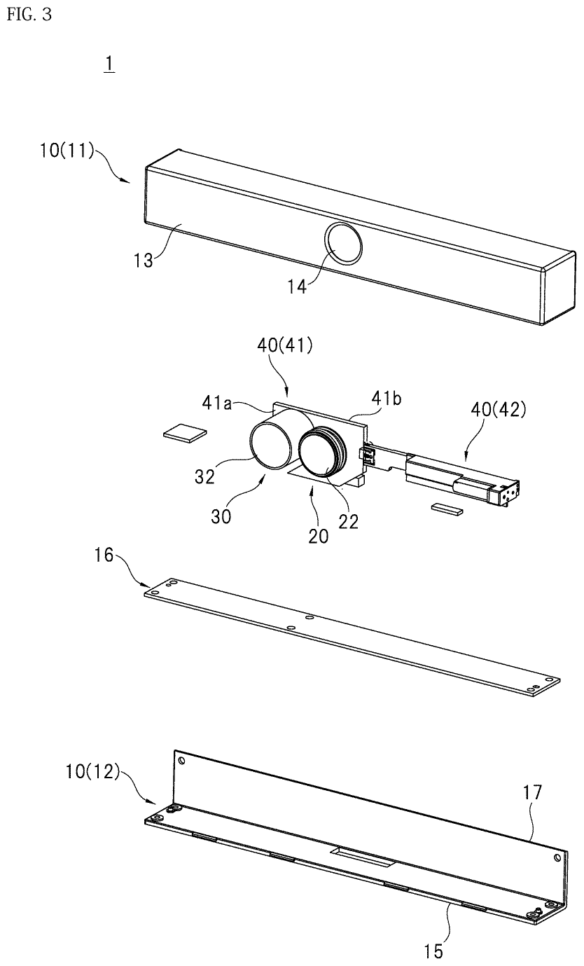

FIG. 3 is an exploded perspective view (expansion view) of the camera 1. As shown in FIGS. 1 to 3, the camera 1 includes a laterally-elongated housing (outer case) 10 including a front case 11 and a rear case 12. In the example described below, the longitudinal direction of the housing 10 is defined as a lateral direction.

The front case 11 has a surface serving as a front surface 13 of the housing 10. The front surface 13 has a circular opening 14 connecting the inside and the outside of the housing 10. In other words, the opening 14 is a through-hole in the front surface of housing 10. Light emitted from an imaging target and passing through the opening 14 enters the housing 10 to be incident on the imaging unit. The opening 14 may hereafter be referred to as an imaging aperture 14. In some embodiments, the opening 14 may be covered with a colorless, transparent cover to prevent dust from entering the inside.

The rear case 12 has a surface serving as a bottom surface 15 of the housing 10. A control board 16 is fixed to the bottom surface 15. The control board 16 is rectangular and has a longitudinal direction parallel to the longitudinal direction of the housing 10. The control board 16 has substantially the same size (area) as the bottom surface 15 of the housing 10, with its four corners fastened to the bottom surface 15 of the housing 10 with screws. The control board 16 receives a controller (control circuit) that centrally controls the camera 1, a memory that stores, for example, programs and data, a power circuit, and other components.

The housing 10 accommodates the main components of the camera 1 including an imaging unit 20, a display unit 30, and a driver 40. The imaging unit 20, the display unit 30, and the driver 40 will be described below.

### Imaging Unit

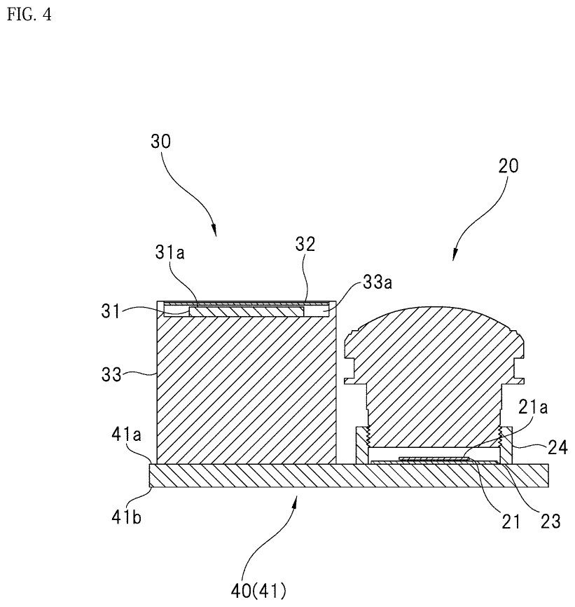

FIG. 4 is a schematic cross-sectional view of the imaging unit 20 and the display unit 30. The imaging unit 20 includes an imaging element (image sensor) 21 and a lens 22 that focuses light incident through the imaging aperture 14 onto a light-receiving surface 21a of the imaging element 21. The imaging element 21 is mounted on a sensor board 23. The lens 22 has the same or substantially the same diameter as the imaging aperture 14. The lens 22 is located above the imaging element 21 and held by a lens holder 24. More specifically, the lens 22 has a lower portion fastened to the lens holder 24 with thread engagement.

Light entering the housing 10 through the imaging aperture 14 is incident on the lens 22. The lens 22 focuses the incident light onto the light-receiving surface 21a of the imaging element 21. In other words, the lens 22 is an imaging optical system that forms an image of the imaging target on the light-receiving surface 21a of the imaging element 21, or at least a part of the imaging optical system. The imaging element 21 converts the brightness of light for the image formed by the lens 22 into electric charge and outputs a signal corresponding to the resultant electric charge. The signal output from the imaging element 21 is transmitted to the control board 16 through the sensor board 23.

### Display Unit

The display unit 30 includes a display 31 with a display surface 31a on which an image appears and a glass cover 32 protecting the display 31. The display 31 is received in a recess 33a on the upper surface of a cylindrical display holder 33. The glass cover 32 is circular and has the same or substantially the same diameter as the imaging aperture 14. The glass cover 32 is fitted in the recess 33a on the display holder 33 and covers the display surface 31a of the display 31. The imaging aperture 14 and the glass cover 32 (display unit 30) may have a shape other than a circle (e.g., rectangle). The glass cover 32 may be eliminated. When the glass cover 32 is eliminated, a cover such as a glass plate may be attached to the imaging aperture 14 or the front surface of the front case 11.

The display 31 in the present embodiment is a liquid crystal display including a glass substrate, a liquid crystal, a polarizer, a color filter, and other components. The display 31 is electrically connected to a driving circuit (not shown) and displays images (e.g., characters, figures, and symbols) on the display surface 31a as controlled by the driving circuit.

The display 31 is not limited to a liquid crystal display. In some embodiments, the display 31 may be an organic electroluminescence (EL) display.

### Driver

As shown in FIG. 3, the driver 40 includes a support 41 on which the imaging unit 20 and the display unit 30 are mounted and an actuator 42 that reciprocates the support 41 in the longitudinal (lateral) direction of the housing 10. The support 41 is a rectangular plate having a longitudinal direction parallel to the longitudinal direction of the housing 10. The support 41 may hereafter be referred to as a base plate 41.

The imaging unit 20 and the display unit 30 are mounted on one main surface (front surface) of the base plate 41. Another main surface (back surface 41b) of the base plate 41 faces a back surface 17 of the housing 10, which is a surface of the rear case 12.

The imaging unit 20 and the display unit 30 are adjacent to each other on the base plate 41 in the longitudinal direction of the housing 10. In other words, the imaging unit 20 and the display unit 30 are laterally adjacent to each other. The imaging unit 20 and the display unit 30 have their centers at the same height. In other words, the line segment connecting the center of the lens 22 and the center of the glass cover 32 is parallel to the longitudinal direction of the housing 10. The centers of the imaging unit 20 and the display unit 30 are also at the same height as the center of the imaging aperture 14.

The actuator 42 mainly includes an electric motor, a feed screw (lead screw), and a movable member to convert rotational motion into linear motion. The feed screw is rotated by the electric motor. The movable member includes a nut engageable with the feed screw with threads and reciprocates in the axial direction of the feed screw as the feed screw rotates. When, for example, the feed screw rotates clockwise, the movable member moves rightward in the axial direction. When the feed screw rotates counterclockwise, the movable member moves leftward in the axial direction.

The feed screw in the actuator 42 has its axial direction parallel to the longitudinal direction of the housing 10. The movable member in the actuator 42 is connected to the base plate 41 on which the imaging unit 20 and the display unit 30 are mounted. When the movable member moves as the feed screw rotates, the imaging unit 20 and the display unit 30 move integrally in the longitudinal direction of the housing 10.

The rotation rate of the feed screw (the rotation rate of the electric motor) is controlled to control, for example, the distances of movements and the positions of the imaging unit 20 and the display unit 30. For example, a detector (e.g., photointerrupter) may detect the positions of the imaging unit 20 and the display unit 30. The detection results from the detector may be used to control the rotation rate of the feed screw (the rotation rate of the electric motor). The detection results from the detector may also be used for, for example, on-off control of the imaging unit 20 and the display unit 30.

### Movements of Imaging Unit and Display Unit

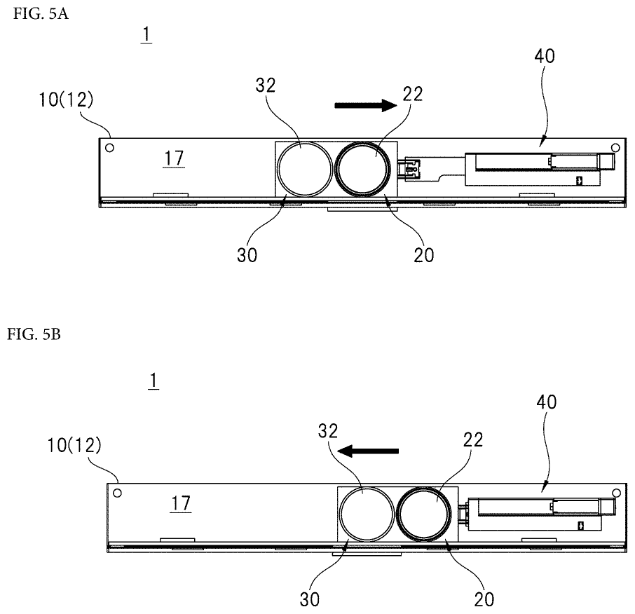

The movements of the imaging unit 20 and the display unit 30 caused by the driver 40 will now be described in detail. The driver 40 moves the imaging unit 20 and the display unit 30 between the position shown in FIG. 5A and the position shown in FIG. 5B. When the imaging unit 20 and the display unit 30 are moved to the position shown in FIG. 5A, the imaging unit 20 is enabled to capture images through the imaging aperture 14 (FIGS. 1 and 3). When the imaging unit 20 and the display unit 30 are moved to the position shown in FIG. 5B, the image displayed by the display unit 30 is visible through the imaging aperture 14 (FIGS. 2 and 3). In other words, the positions of the imaging unit 20 and the display unit 30 shown in FIG. 5A correspond to a first position in an aspect of the present invention. The positions of the imaging unit 20 and the display unit 30 shown in FIG. 5B correspond to a second position in an aspect of the present invention.

When the imaging unit 20 and the display unit 30 are moved to the first position (FIG. 5A) from the second position (FIG. 5B) by the driver 40, the lens 22 in the imaging unit 20 faces the imaging aperture 14 (FIGS. 1 and 3). This allows light entering the housing 10 through the imaging aperture 14 to reach the light-receiving surface 21a of the imaging element 21 through the lens 22. In other words, the camera 1 enters the imaging mode. The display unit 30, adjacent to the imaging unit 20, is then out of the imaging aperture 14 and hidden behind the front surface 13 of the housing 10.

When the imaging unit 20 and the display unit 30 are moved to the second position (FIG. 5B) from the first position (FIG. 5A) by the driver 40, the display 31 in the display unit 30 faces the imaging aperture 14 (FIGS. 2 and 3). More specifically, the display 31 faces the imaging aperture 14 (FIGS. 2 and 3) through the glass cover 32. This allows the image on the display surface 31a of the display 31 to be visible through the imaging aperture 14. The imaging unit 20, adjacent to the display unit 30, is then out of the imaging aperture 14 and hidden behind the front surface 13 of the housing 10. In other words, the camera 1 enters the non-imaging mode.

As described above, the imaging unit 20 and the display unit 30 included in the camera 1 are moved integrally between the first position and the second position in the housing 10. When the imaging unit 20 and the display unit 30 are moved to the first position, the imaging unit 20 is enabled to capture images. When the imaging unit 20 and the display unit 30 are moved to the second position, the imaging unit 20 is disabled from capturing images. In other words, the camera 1 is switchable between the imaging mode and the non-imaging mode.

Additionally, when the imaging unit 20 and the display unit 30 are moved to the second position and the camera 1 enters the non-imaging mode, the display unit 30 may display a predetermined message indicating that the camera 1 is in the non-imaging mode. This allows a person being imaged to notice that the camera 1 is in the non-imaging mode.

The display unit 30 may display an image other than a specific message when the imaging unit 20 and the display unit 30 are at the second position. For example, the display unit 30 may display the company name or the emblem of the manufacturer or the distributor of the camera 1. The display unit 30 may also display time or other information.

The present invention is not limited to the above embodiment, but may be modified variously without departing from the spirit and scope of the invention. In some embodiments, the housing may have grooves or protrusions to guide the movement of the support on which the imaging unit and the display unit are mounted. The imaging unit and the display unit movable integrally may not be mounted on the same support.

In some embodiments, the structure may include a magnification optical system that magnifies an image appearing on the display of the display unit or a projection optical system that projects an image appearing on the display. For example, the magnification optical system and the projection optical system may include one or more lenses, mirrors, prisms, and other components. The driver may have any structure or form. In some embodiments, the driver may include a rack and a pinion.

What is claimed is:

1. A camera, comprising:
an imaging unit;
a display unit configured to display an image;
a driver configured to move the imaging unit and the display unit integrally; and
a housing having an opening connecting an inside and an outside of the housing, the housing accommodating the imaging unit, the display unit, and the driver,
wherein the driver moves the imaging unit and the display unit to a first position at which the imaging unit is enabled to capture an image through the opening, and
the driver moves the imaging unit and the display unit to a second position at which an image displayed by the display unit is visible through the opening.

2. The camera according to claim 1, wherein
the imaging unit includes an imaging element and a lens configured to focus light incident through the opening onto the imaging element,
the display unit includes a display to display an image,
the lens faces the opening in response to the imaging unit and the display unit being moved to the first position, and
the display faces the opening in response to the imaging unit and the display unit being moved to the second position.

3. The camera according to claim 2, wherein
the display includes a liquid crystal display or an organic electroluminescence display.

4. The camera according to claim 1, wherein
the imaging unit and the display unit are adjacent to each other in a longitudinal direction of the housing, and
the driver reciprocates the imaging unit and the display unit in the longitudinal direction of the housing.

5. The camera according to claim 4, wherein
the driver includes a support on which the imaging unit and the display unit are mounted and an actuator configured to reciprocate the support in the longitudinal direction of the housing.
